(19) United States
(12) Patent Application Publication
(10) Pub. No.: US 2013/0306891 A1
(43) Pub. Date: Nov. 21, 2013

(54) MAGNET VALVE, AND DRIVER ASSISTANCE DEVICE COMPRISING SUCH A MAGNET VALVE

(71) Applicants: Klaus-Dieter Fietz, Oberriexingen (DE); Volker Unsoeld, Marbach (DE); Manfred Maerz, Ludwigsburg (DE); Valentin Schubitschew, Asperg (DE); Scott Ducworth, Summerville, SC (US)

(72) Inventors: Klaus-Dieter Fietz, Oberriexingen (DE); Volker Unsoeld, Marbach (DE); Manfred Maerz, Ludwigsburg (DE); Valentin Schubitschew, Asperg (DE); Scott Ducworth, Summerville, SC (US)

(73) Assignee: Robert Bosch GmbH, Stuttgart (DE)

(21) Appl. No.: 13/812,158

(22) PCT Filed: Jun. 10, 2011
(86) PCT No.: PCT/EP11/59715

§ 371 Date: Aug. 1, 2013

(30) Foreign Application Priority Data
Aug. 4, 2010 (DE) 102010038900

(51) Int. Cl. F16K 47/02; F16K 31/06

(52) U.S. Cl. CPC F16K 47/023; F16K 31/0658
USPC 251/120; 251/129.15

(57) ABSTRACT

A magnet valve includes a magnet armature connected to a sealing element and configured to displace the sealing element. The magnet armature has faces. The magnet valve also includes fluid chambers and a flow path via which fluid chambers that lie on opposing faces of the magnet armature are fluidically connected. A damping element is arranged in the magnet valve and is configured to be displaced in an axial direction. The damping element protrudes into the flow path at least in some regions.

### PRIOR ART

The invention relates to a magnet valve having a magnet armature, which is operatively connected to a sealing element of the magnet valve in order to displace said element, and having at least one flow path, via which fluid chambers arranged on opposite sides of the magnet armature can be connected fluidically or are connected fluidically. The invention furthermore relates to a driver assistance device.

Magnet valves of the type stated at the outset are known from the prior art. They are usually used for driver assistance devices, in particular ABS, TCS or ESP devices. The magnet valve has the magnet armature, which is arranged in the magnet valve in such a way that it can be displaced, in particular axially. The magnet armature is operatively connected to the sealing element of the magnet valve, and therefore, when the magnet armature is displaced, the sealing element is also displaced. The sealing element is usually provided for the purpose of closing or exposing a valve opening of the magnet valve. When the sealing element is arranged for the purpose of closing the valve opening, it is usually seated in a magnet valve seat which is assigned both to the valve opening and to the sealing element. For example, the sealing element is introduced into a recess in the magnet armature and held in the latter, the recess preferably being provided on an end of the magnet armature facing away from the armature counterpart.

The magnet valve usually has an actuating device, which is formed by the magnet armature, together with an armature counterpart. In addition to the magnet armature, the magnet valve thus also has the armature counterpart. This is designed as a pole core, for example. The pole core is usually held in a fixed location relative to a housing of the magnet valve, while the magnet armature can be displaced relative to the housing. To bring about this displacement, the magnet armature and the armature counterpart interact. In this arrangement, the armature counterpart has one or more coils, for example, while the magnet armature consists of a magnetizable or magnetic material. The armature counterpart is provided at the end of the magnet armature. The magnet armature and the armature counterpart are usually arranged relative to one another in such a way that they cannot come into connection with one another, irrespective of the displacement of the magnet armature. There is therefore a gap, referred to as the “air gap” or “working air gap”, between the magnet armature and the armature counterpart or between the end of the magnet armature facing the armature counterpart and the end of the armature counterpart facing the magnet armature. The size of the air gap is dependent on the position of the magnet armature in relation to the armature counterpart. The size of the air gap accordingly changes as the magnet armature is displaced.

The fluid chambers are situated on opposite sides of the magnet armature, and the air gap is formed at least over a certain area by one of the fluid chambers. The fluid chamber volume of the fluid chambers is dependent on the position of the magnet armature relative to the armature counterpart. In order to avoid a sharp pressure buildup or pressure drop in one of the fluid chambers or in the fluid chambers during a displacement of the magnet armature, the fluid chambers can be connected fluidically or are connected fluidically by the flow path. This means that, when the magnet armature is displaced, fluid is forced out of the fluid chamber in the direction of which the magnet armature is being displaced and into the fluid chamber in the opposite direction from the displacement. In conventional embodiments of the magnet valve, the flow path is formed in part by the magnet armature itself. For example, the flow path lies between the magnet armature and the housing of the magnet valve in which the magnet armature is guided in an axially movable manner. The flow path is therefore defined by an outer contour of the magnet armature and an inner contour of the housing. During a displacement of the magnet armature, it is quite possible that the fluid chamber volume of one of the fluid chambers will be reduced to zero; in this case, therefore, the fluid chamber is therefore only present in a figurative sense.

During its displacement, the magnet armature of the magnet valve moves at a certain speed. The higher this speed is, the greater are pressure waves produced when the sealing element strikes the valve seat. When they strike a wall, these pressure waves are converted into sound, and therefore the operation of the magnet valve gives rise to unwanted noises. In general terms, these noises are louder, the higher the speed at which the magnet armature is displaced. One known way of counteracting this problem is to increase the damping of the magnet valve, e.g. by reducing the flow cross section of the flow path. In this way, the speed at which the magnet armature can be displaced is reduced. However, the result is that the maximum achievable speed of actuation of the magnet valve is also reduced, that is to say the minimum achievable actuating time of the magnet valve is increased. There are thus two opposing optimization aims to choose from in designing a magnet valve. On the one hand, the production of pressure waves or sound by the magnet valve can be reduced or, on the other hand, the speed of actuation can be increased.

### DISCLOSURE OF THE INVENTION

Compared with the above, the magnet valve having the features stated in claim 1 has the advantage that it operates both with little vibration and with little noise and, at the same time, allows a high speed of actuation. According to the invention, this is achieved by arranging at least one damping element in an axially displaceable manner in the magnet valve, said damping element protruding into the flow path at least over a certain area. The damping element can increase the damping of the magnet valve or magnet armature by reducing the flow cross section of the flow path and increasing the effective magnet armature cross section situated in the flow path. This is achieved by virtue of the fact that the damping element—which is usually assigned to the magnet armature—protrudes into the flow path at least over a certain area. The intention is that the damping element should be displaceable in the axial direction, in particular relative to the magnet armature. Thus, it is displaceable at least between a first and a second position. The damping element can be arranged on the magnet armature or on another element bounding the flow path, e.g. the housing of the magnet valve. It is advantageous if the damping element projects beyond the outer contour of the magnet armature in the radial direction. In an alternative embodiment, however, provision could also be made for the flow path via which the fluid chambers can be connected fluidically to be produced by means of a recess or aperture in the magnet armature. In this case, the damping element can likewise be arranged in a damping element chamber of the magnet armature.

In particular, the damping element is arranged so as to be displaceable in the axial direction in such a way that the damping of the magnet valve is increased only in at least one position while, in at least one other position, damping is unchanged. Here, provision is advantageously made for the damping of the magnet valve to be increased during a closing operation of the magnet valve, just before the sealing element comes into contact with the sealing seat. In this way, the speed of the magnet armature is reduced only in a range of positions that is chosen so that low-noise closure of the magnet valve is made possible. Accordingly, the damping element is provided for the purpose of reducing the flow cross section of the flow path only in a first range of positions of the magnet armature and hence of increasing the damping of the magnet valve in said range. In a second range of positions, on the other hand, which is different from the first range of positions, the flow cross section of the flow path and hence the damping of the magnet valve is to remain unchanged.

In the first range of positions, the displacement of the magnet armature is thus delayed, with the result that it moves at a lower speed in said range. In the second range of positions, in contrast, movement of the magnet armature at a higher speed is permitted. Quieter closing is therefore achieved as compared with magnet valves known from the prior art but without significantly reducing the (average) speed of the magnet armature. Only in the first range of positions, which represents only a (small) range of the total actuating travel of the magnet armature between the open position—in which the valve seat is exposed by the sealing element—and the closed position—in which the valve seat is closed by the sealing element—is there a reduction in the speed of the magnet armature, and therefore the speed of actuation of the magnet valve remains virtually unchanged.

A development of the invention provides for the damping element to be displaceable in the axial direction by a fluid flow along the flow path brought about by a movement of the magnet armature. As already explained above, the movement or displacement of the magnet armature brings about the fluid flow along the flow path, with the fluid flowing from one of the fluid chambers into the other of the fluid chambers or vice versa. Owing to the fact that the damping element protrudes into the flow path, the fluid flow along the flow path brings about an actuating force on the damping element. This actuating force brings about the displacement of the damping element in the axial direction. For this reason, provision is usually made for the damping element to be supported in such a way that it can be displaced easily by the fluid flow. In particular, no additional actuating means are provided or needed to displace the damping element.

A development of the invention provides for the magnet armature to have at least one end stop to limit an axial displacement of the damping element. The axial displacement of the damping element takes place relative to the magnet armature. When the damping element reaches the position of the end stop, said stop prevents further displacement of the damping element relative to the magnet armature. Thus, the end stop immobilizes the damping element in at least one axial direction as soon as it has reached a particular position relative to the magnet armature. If the magnet armature is subsequently displaced counter to this axial direction, the damping element is taken along by the magnet armature by way of the end stop. In this way, the effective cross section of the magnet armature is increased by that of the damping element and the flow cross section of the flow path is reduced and hence the damping of the magnet valve is increased.

A development of the invention provides for the damping element to be mounted in a groove in the magnet armature. The groove can be formed over part of the circumference of the magnet armature or just in one or more regions of the circumference. In this arrangement, the damping element is seated in the groove in such a way that it is supported relative to the magnet armature. The groove can form the at least one end stop, for example, and preferably two opposite end stops.

A development of the invention provides for the groove in the magnet armature to be situated between component elements of the magnet armature. The magnet armature is thus of multi-part, in particular two-part, design. Such a configuration of the magnet valve or magnet armature allows easy mounting of the damping element on the magnet armature. In particular, the damping element is assembled with a first of the component elements, and then at least one further component element of the component elements is mounted on the first of the component elements. The damping element is then seated in the groove in the magnet armature and is held captive in said groove. The damping element can only be removed from the groove if the component elements are disassembled from one another.

A development of the invention provides for one of the component elements to engage at least over a certain area, in particular with a clamping action, in another of the component elements. To enable the component elements to be fixed to one another, provision is accordingly made for them to engage in one another. In this way, nonpositive or positive fixing to one another can be achieved. It is particularly advantageous if the component elements engage in one another in such a way that a clamped joint is achieved. As an alternative, however, it would also be possible for a screwed joint, for example, to be provided between the component elements.

A development of the invention provides for the damping element to reach around the magnet armature at least over a certain area, in particular completely. The damping element is thus provided on an outer contour of the magnet armature. In this arrangement, provision is made for the damping element to engage around the magnet armature at least over a certain area, with the result that the damping element protrudes into at least one circumferential area of the flow path. It is particularly advantageous if the damping element reaches completely around the magnet armature, thus making it possible for the damping element to act on the entire flow path—when seen in cross section.

A development of the invention provides for the damping element to have larger dimensions in the radial direction than the magnet armature. Thus, the damping element projects beyond the magnet armature in the radial direction to such an extent that it protrudes further into the flow path than the magnet armature. In this way, the damping element can increase the damping of the magnet valve in the first range of positions of the magnet armature.

A development of the invention provides for the magnet armature to have a radial bearing for the damping element. The radial bearing guides the damping element in the axial direction and, at the same time, prevents movement in the radial direction. Ideally, the radial bearing and the damping element are embodied in such a way that tilting of the damping element relative to the magnet armature is also prevented.

The invention furthermore relates to a driver assistance device, in particular an ABS, TCS or ESP device, having at least one magnet valve, in particular according to the above explanations, wherein the magnet valve has a magnet armature, which is operatively connected to a sealing element of the magnet valve in order to displace said element, and has at least one flow path, via which fluid chambers situated on opposite sides of the magnet armature can be connected fluidically or are connected fluidically. In this arrangement, provision is made for at least one damping element to be arranged in an axially displaceable manner in the magnet valve, said damping element protruding into the flow path at least over a certain area. The magnet valve of the driver assistance device can be refined in accordance with the explanations given above.

The invention is explained in greater detail below by means of the illustrative embodiments shown in the drawing but without restricting the invention. In the drawing:

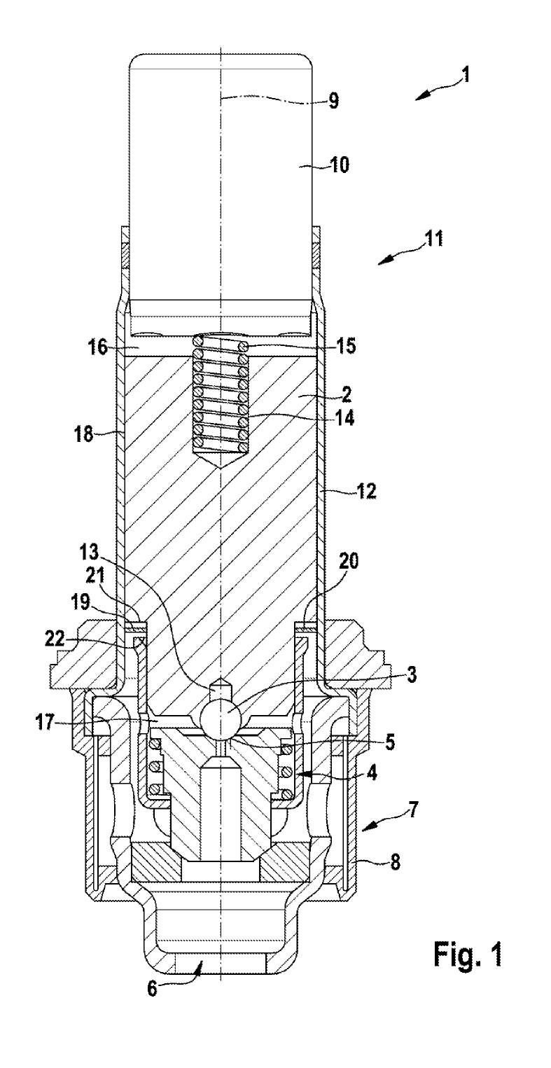

FIG. 1 shows a sectioned side view of a magnet valve having a magnet armature, to which a damping element is assigned,

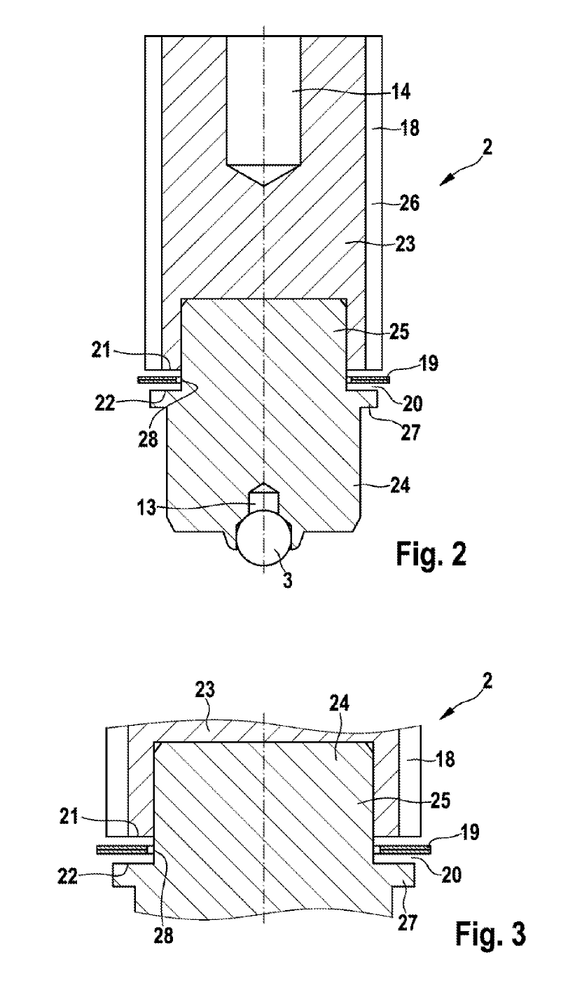

FIG. 2 shows the magnet armature and the damping element,

FIG. 3 shows the damping element in a first position,

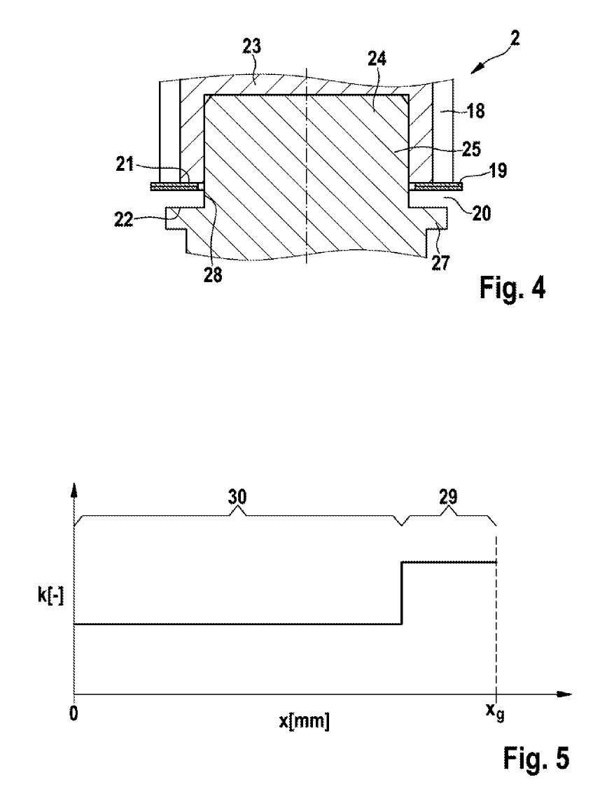

FIG. 4 shows the damping element in a second position, and

FIG. 5 shows a diagram in which damping of the magnet valve is shown against the actuating travel of the magnet armature.

The figure shows a magnet valve 1, which is part of a driver assistance device, for example (not shown here). The magnet valve 1 has a magnet armature 2, which is operatively connected to a sealing element 3 of the magnet valve 1. The sealing element 3 interacts with a valve seat 5 formed in a valve body 4 in order to open and interrupt a flow connection between an inlet port 6 and an outlet port 7 of the magnet valve 1. In the illustrative embodiment shown here, the outlet port 7 is assigned a filter 8. In addition or as an alternative, it is, of course, also possible to assign a filter to the inlet port 6 (not shown here). The magnet valve 1 illustrated here is designed to provide an arrangement of the inlet port 6 and the outlet port 7 for axial inflow and radial outflow (relative to a longitudinal axis 9 of the magnet valve 1). It is self-evident, however, that the direction of inflow and the direction of outflow provided are a matter of free choice.

In addition to the magnet armature 2, which has a substantially circular cross section, the magnet valve 1 has an armature counterpart 10, which, together with the magnet armature 2, forms an actuating device 11 for the magnet valve 1. The armature counterpart 10 is designed as a pole stage, for example, and has at least one electric coil, making it possible to apply a magnetic force to the magnet armature 2 by means of the armature counterpart 10 by applying a voltage across the coil (i.e. by energizing the magnet valve 1). The magnet armature 2 is supported in a manner which allows it to be displaced axially relative to the longitudinal axis 9, support being provided, in particular, by means of a housing 12 of the magnet valve 1. In this arrangement, the armature counterpart 10 and the valve body 4 are also held in a fixed location on the housing 12. Under the influence of the magnetic force produced by means of the armature counterpart 10, the magnet armature 2 can thus be displaced in the axial direction relative to the magnet armature 2 and to the valve body 4. The magnet valve 1 illustrated in the figure is a magnet valve 1 that is closed when deenergized. This means that the sealing element 3 is seated in a sealing manner in the valve seat 5 as long as the magnet valve 1 is not energized, i.e. while no magnetic force is being produced by means of the armature counterpart 10.

The sealing element 3 is introduced into a stepped bore 13 on the opposite side of the magnet armature 2 from the armature counterpart 10. In this arrangement, the sealing element 3 is preferably pressed into the stepped bore 13, with the result that it is held with a clamping action therein. A spring element 15 is arranged in another recess 14 in the magnet armature 2 in such a way that it enters into effective contact both with the magnet armature 2 and with the armature counterpart 10. The spring element 15, which is designed as a spiral spring in this case, brings about a spring force that acts on the magnet armature 2, and it is supported on the armature counterpart 10. The spring force urges the magnet armature 2 in the direction away from the armature counterpart 10. If the magnet valve 1 is energized, that is to say if the corresponding magnetic force, which is directed toward the armature counterpart 10 in the illustrative embodiment shown here, acts on the magnet armature 2, the magnet armature 2 is moved toward the armature counterpart 10. During this process, the spring element 15 is subjected to (an additional) load. If the magnetic force is removed, the spring force has the effect that the magnet armature 2 is pushed away from the armature counterpart 10 again.

Fluid chambers 16 and 17 are provided on opposite sides of the magnet armature 2. In order to avoid a pressure buildup or pressure drop in the fluid chambers 16 and 17 during a displacement of the magnet armature 2, and hence to make problem-free adjustment of the magnet armature 2 possible at all, the fluid chambers 16 and 17 are connected to one another by a flow path 18. In the illustrative embodiment shown here, the flow path 18 is formed between an outer contour of the magnet armature 2 and an inner contour of the housing 12. For this purpose, the magnet armature 2 has smaller dimensions in the radial direction at each axial position than a space within the housing 12, in which the magnet armature 2 is guided.

In FIG. 1, the magnet armature 2 is illustrated in the closed position thereof. In order to displace it into the open position thereof, the magnet valve 1 is energized, thereby producing a magnetic force by means of the armature counterpart 10, which displaces the magnet armature 2 in the direction of the armature counterpart 10. During this process, the valve seat 5 is exposed by the sealing element 3. If the valve seat 5 is to be closed again, the magnet valve 1 is deactivated, with the result that the magnetic force disappears and the spring force produced by the spring element 15 urges the magnet armature 2 and hence the sealing element 3 in the direction of the valve seat 5. The distance traveled by the magnet armature 2 between the open position and the closed position thereof or vice versa is referred to below as the actuating travel.

In order to achieve the short actuating times which are required in the case of many magnet valves 1, the magnet armature 2 must be displaced at a comparatively high speed. The term “actuating time” is taken to mean the time required to displace the magnet armature 2 from the open position thereof to the closed position or vice versa. Especially when the valve seat 5 is being closed by the sealing element 3, i.e. when the magnet armature 2 is being displaced into the closed position thereof (as illustrated in FIG. 1), pressure waves therefore occur, and these can cause troublesome noises. Magnet valves 1 which have greater damping, resulting in slower displacement of the magnet armature 2, have therefore been proposed. The greater damping is achieved by means of a smaller flow cross section of the flow path 18. This enables the magnet valve 1 to be operated with little noise. However, this measure also entails a longer actuating time of the magnet valve 1.

In order to enable low-noise operation of the magnet valve 1 with short actuating times, a damping element 19 is provided which protrudes into the flow path 18 between the fluid chambers 16 and 17, at least over a certain area. The damping element 19 is mounted in a groove 20 in the magnet armature 2, the groove 20 having a greater width in the axial direction than the damping element 19. This enables the damping element 19 to be displaced in the axial direction. In the illustrative embodiment shown here, the damping element 19 is accordingly assigned to the magnet armature 2. The damping element 18 can be displaced in the axial direction by a fluid flow along the flow path 18 brought about by the movement of the magnet armature 2. The groove 20 forms two end stops 21 and 22 for the damping element 19. The end stops 21 and 22 limit the axial displacement of the damping element 19 relative to the magnet armature 2.

FIG. 2 shows a detail view of the magnet armature 2 and of the damping element 19. It will be apparent that the magnet armature 2 consists of two component elements 23 and 24. In this arrangement, the groove 20 lies between the component elements 23 and 24. Component element 24 engages at least over a certain area in component element 23. In this way, a clamped joint between the component elements 23 and 24 is created, ensuring that the damping element 19 is held captive in the groove 20. During assembly of the magnet valve 1, the damping element 19 is therefore first of all placed on a central spigot 25 of component element 24, with the result that it preferably comes into physical contact with end stop 22 or rests on the latter. Component element 23 is then pressed onto the spigot 25 of component element 24, creating a permanent joint between component elements 23 and 24. In the region of component element 23, the flow path 18 is subdivided by radial projections 26, which emanate from component element 23 and project toward the housing 12. Component element 24 has a radial projection 27, which is formed so as to run around in the circumferential direction. Radial projection 27 is shorter in the radial direction than the radial projections 26 of the impact element 23. Starting from radial projection 27, the cross section of component element 24 decreases in the direction of the sealing element 3 by a radial step.

It is apparent from FIG. 2 that the damping element 19 reaches around the magnet armature 2 completely in the circumferential direction. It can likewise be seen that it has larger dimensions in the radial direction than the magnet armature 2 or component elements 23 and 24 thereof. In the groove 20, there is a radial bearing 28 for the damping element 19. This bearing is formed by the magnet armature 2. The radial bearing 28 allows only axial displacement of the damping element 19 relative to the magnet armature 2 and, accordingly, essentially prevents movement of the damping element 19 in the radial direction and tilting of the damping element 19.

The mode of operation of the damping element 19 and of the magnet valve 1 having the damping element 19 will be explained with reference to FIGS. 3 and 4. FIG. 3 shows an area of the magnet armature 2, with the magnet armature 2 being in the open position thereof. In this case, the damping element 19 occupies the position illustrated in FIG. 3, for example. It is moved into this position by return means, for example (not shown here). These return means comprise, for example, at least one spring element, which acts between the magnet armature 2 and the damping element 19 in order to urge the damping element 19 into the position illustrated in FIG. 3. There is preferably at least one spring element arranged on each side of the damping element 19 in the groove 20. Ideally, two spring elements are provided diametrically opposite one another in each case. Four or more spring elements are preferably used.

If the magnet armature 2 is displaced in the direction of the closed position thereof in order to cover the valve seat 5 by means of the sealing element 3, the flow cross section of the flow path 18 and the damping of the magnet valve 1 are initially unchanged. There is therefore a low level of damping and a high speed of actuation of the magnet armature 2 in a second range of positions. During the displacement of the magnet armature 2, fluid flows out of fluid chamber 17 into fluid chamber 16 along the flow path 18. This flow or fluid flow brings about an actuating force on the damping element 19, which urges it in the direction of end stop 21 of the magnet armature 2.

Once the magnet armature 2 has been displaced by a sufficient amount, the damping element 19 rests on end stop 21. This is illustrated in FIG. 4. It can readily be seen that, as soon as the damping element 19 is resting on end stop 21, it is taken along by the magnet armature 2 in the direction of the closed position thereof. The damping element 19 is thus displaced together with the magnet armature 2 counter to the fluid flow along the flow path 18. This brings about a significant increase in the damping of the magnet valve 1. The speed of displacement of the magnet armature 2 is thus reduced.

The first range of positions thus contains the positions of the magnet armature 2 in which the coupling element 19 rests on end stop 21. The second range of positions, on the other hand, contains the positions of the magnet armature 2 in which the damping element 19 is not yet resting on end stop 21.

FIG. 5 shows a diagram in which the damping k of the magnet valve 1 is shown against the actuating travel x of the magnet armature 2. Here, the damping is dimensionless, while the actuating travel of the magnet armature 2 is given in millimeters. An actuating travel of zero here means that the magnet armature 2 is in the open position thereof, while an actuating travel of x_{g} means that the magnet armature 2 is in the closed position thereof. The diagram in FIG. 5 shows that the damping of the magnet valve 1 is greater in the first range of positions 29 than in the second range of positions 30. It is thus evident that the damping of the magnet valve 1 is increased only in a small range of positions—relative to the total actuating travel. In this way, low noise operation of the magnet valve 1 with, at the same time, a high speed of actuation is made possible.

1. A magnet valve comprising:
a sealing element;
a magnet armature operatively connected to the sealing element and configured to displace the sealing element, the magnet armature having opposite sides;
a plurality of fluid chambers arranged on the opposite sides of the magnet armature;
at least one flow path fluidically connecting the plurality of fluid chambers; and
at least one damping element arranged to move in an axial direction and protruding into the at least one flow path at least over a certain area.

2. The magnet valve as claimed in claim 1, wherein:
the at least one damping element is configured to be displaced in the axial direction by a fluid flow along the at least one flow path, and
the fluid flow is generated brought about by a movement of the magnet armature.

3. The magnet valve as claimed in claim 1, wherein the magnet armature has at least one end stop configured to limit an axial displacement of the at least one damping element.

4. The magnet valve as claimed in claim 1, wherein the at least one damping element is mounted in a groove in the magnet armature.

5. The magnet valve as claimed in claim 4, wherein the groove in the magnet armature is situated between a plurality of component elements of the magnet armature.

6. The magnet valve as claimed in claim 5, wherein a first component element of the plurality of component elements is configured to engage at least a portion of a second component element of the plurality of component elements with a clamping action.

7. The magnet valve as claimed in claim 1, wherein the at least one damping element reaches around the magnet armature at least over a certain area.

8. The magnet valve as claimed in claim 1, wherein:
the at least one damping element has a radial dimension,
the magnet armature has a radial dimension, and
the radial dimension of the at least one damping element is larger than the radial dimension of the magnet armature.

9. The magnet valve as claimed in claim 1, wherein the magnet armature has a radial bearing configured to bear the at least one damping element.

10. A driver assistance device comprising:
at least one magnet valve including:
a sealing element;
a magnet armature connected to the sealing element and configured to displace the sealing element, the magnet armature having opposite sides;
a plurality of fluid chambers arranged on the opposite sides of the magnet armature;
at least one flow path fluidically connecting the plurality of fluid chambers; and
at least one damping element is arranged to move in an axial direction and protruding into the at least one flow path at least over a certain area.
